(19) United States
(12) Patent Application Publication
(10) Pub. No.: US 2011/0319588 A1
(43) Pub. Date: Dec. 29, 2011

(54) ISOTACTIC POLYLACTIC ACID AND METHOD FOR PRODUCING SAME

(75) Inventors: Thierry Coupin, Carnieres (BE); Philippe Coszach, Escanaffles (BE); Delphine Hottois, Escanaffles (BE)

(73) Assignee: FUTEERRO S.A., Escanaffles (BE)

(21) Appl. No.: 13/143,379

(22) PCT Filed: Jan. 15, 2010
(86) PCT No.: PCT/EP2010/050477

§ 371 Date: Sep. 14, 2011

(30) Foreign Application Priority Data
Jan. 16, 2009 (BE) BE 2009/0028

(51) Int. Cl. C08G 63/08

(52) U.S. Cl. 528/355; 528/354

(57) ABSTRACT

Method of polymerization for producing polylactic acid of configuration L or D, with number-average molecular weight between 60 000 and 200 000 having an insertion defect rate between 0 and 0.5 wt. % of polylactic acid and a racemization defect rate between 0 and 2.5 wt. % of polylactic acid, characterized in that the method is a bulk process comprising contacting, at a temperature between 170 and 200° C. and for a reaction time between 5 and 75 minutes, the corresponding lactide of stereochemical configuration L-L or D-D having an optical purity of L or D of at least 99.5 wt. % with at least one catalyst in the presence of an initiator to form poly-L-lactic acid or poly-D-lactic acid.

### TECHNICAL FIELD OF THE INVENTION

The invention relates to a method of polymerization for obtaining an isotactic lactide polymer. The invention also relates to said polymer and use thereof in known applications, notably in the area of packaging, textiles and durable goods.

### TECHNOLOGICAL BACKGROUND OF THE INVENTION

Synthetic polymers based on petrochemicals had a very important industrial impact in the middle of the 20th century. Despite the many advantages of these materials, two drawbacks still remain to be solved: the use of non-renewable resources for their production and utilization at the end of their life. Taking into account their intrinsic properties, biodegradable polymers have therefore become an important alternative and much progress has been made both from the standpoint of synthesis and of processing of these materials. Moreover, the latter are used for many applications such as packaging and textiles. Among the various biodegradable polymers, polylactic acid (PLA) is one of the most commonly used and studied.

Even though it is a homopolymer, polylactic acid can vary in its structure with respect to its stereoregularity. Poly-L-lactic acid, resulting from the polymerization of L-lactide, and poly-D-lactic acid, resulting from the polymerization of D-lactide, are enantiomers with isotactic stereoregularity, whereas polymerization of the meso-lactide gives a syndiotactic polylactic acid.

U.S. Pat. No. 6,166,169 relates to an aliphatic polyester obtained by polymerization of at least one monomer selected from the group comprising lactides, lactones, cyclic carbonates and cyclic anhydrides.

One of the problems encountered in the prior art with polymers of polylactic acid is their low heat resistance. The products manufactured subsequently with these resins tend to deform easily when they are exposed to a temperature above their glass transition temperature. This low heat resistance is even more important as the polymers of polylactic acid produced by synthesis have very low crystallinity. Accordingly, resins or polymers of polylactic acid are not always suitable for high-temperature applications, for example beakers for hot drinks, packaging of hot substances or packaging intended for use in a microwave oven. At present, these polymers of polylactic acid therefore have several drawbacks, notably a high insertion defect rate and rate of racemization defects inserted in the polymer chain. There is therefore a need for production of a polymer of polylactic acid having a lower insertion defect rate and racemization defect rate. Now, at present, it would seem that the method of solution polymerization does not really allow such a polymer of polylactic acid to be obtained at reasonable economic cost. In fact, the method of solution polymerization has the disadvantage of a generally long reaction time and the need to separate the polymer obtained from the solvent, at the end of the polymerization process. There is therefore a need to develop a method of industrial polymerization that does not have the drawbacks mentioned above, while making it possible to obtain polymers of polylactic acid with a very low rate of defects inserted in the polymer chain.

The aim of the present invention is to provide a method of bulk polymerization for producing isotactic polylactic acid possessing a low tacticity defect rate.

Another aim of the present invention is to provide a method of bulk polymerization for producing isotactic polylactic acid with improved crystallinity.

Another aim of the present invention is to provide a method of bulk polymerization for producing isotactic polylactic acid with improved heat resistance as well as that of the objects that can be produced therefrom.

Yet another aim of the present invention is to provide a method of bulk polymerization for producing isotactic polylactic acid with improved rigidity.

At least one of the aims mentioned above is achieved with the present invention.

The present invention therefore has the aim of rectifying at least one of the drawbacks mentioned above.

### DETAILED DESCRIPTION OF THE INVENTION

The applicant has found that if the polymerization of lactide is carried out according to the conditions of bulk polymerization of the present invention, a polymer of polylactic acid with a very low rate of tacticity defects is obtained. Furthermore, the method of bulk polymerization of the invention is particularly suitable for industrial exploitation. In fact, it permits rapid production of the polymer and permits, with optional drying, direct exploitation of the polymer, in contrast to the solution process, at the end of which the polymer obtained must be separated from the solvent, which on the one hand increases the complexity of the process and on the other hand affects its profitability.

The applicant has also found that because of its crystallinity it is possible to dry the polylactic acid according to the invention at higher temperatures and therefore with increased productivity. The effectiveness of drying makes it possible to avoid degradation of the product by hydrolysis during processing thereof and thus maintain the mechanical properties of the product. This increase in crystallinity also facilitates the stages of packaging and storage of the product.

The present invention relates to a method of bulk polymerization for obtaining:
polylactic acid of configuration L, with number-average molecular weight between 60 000 and 200 000 having a percentage of dimer unit D-D of formula (Ia)

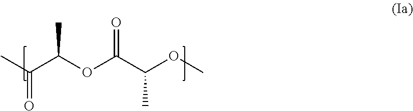

between 0 and 0.5 wt. % of poly-L-lactic acid and a percentage of dimer unit D-L and/or L-D of formulae (II) and (III)

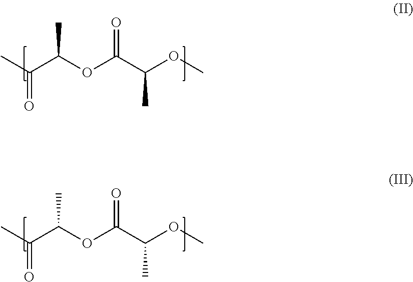

between 0 and 2.5 wt. % of poly-L-lactic acid,
or
polylactic acid of configuration D, with number-average molecular weight between 60 000 and 200 000 having a percentage of dimer unit L-L of formula (Ib)

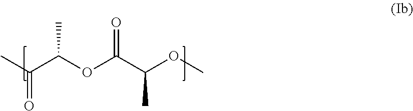

between 0 and 0.5 wt. % of poly-D-lactic acid and a percentage of dimer unit D-L and/or L-D of formulae (II) and (III)

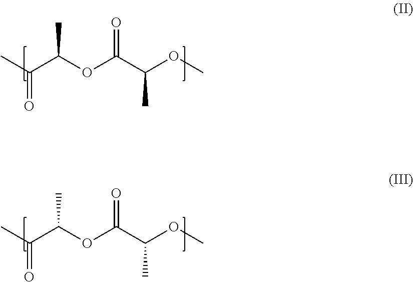

between 0 and 2.5 wt. % of poly-D-lactic acid, characterized in that bulk polymerization is carried out, consisting of bringing into contact, at a temperature between 170 and 200° C. and for a reaction time between 5 and 75 minutes, the corresponding lactide of stereochemical configuration L-L or D-D having an optical purity of L or D of at least 99.5 wt. % with at least one catalytic system and in the presence of an initiator to form poly-L-lactic acid or poly-D-lactic acid.

According to the present invention, the percentage of dimer unit LL in a D polymer or of dimer unit DD in an L polymer is defined as being “an insertion defect percentage”.

According to the present invention, the percentage of dimer unit LD and/or DL in an L or D polymer respectively is defined as being “a racemization defect percentage” or “percentage of mesolactide equivalent”.

The present invention therefore relates to a method of bulk polymerization for obtaining an isotactic polylactic acid of configuration L or D that has an insertion defect rate between 0 and 0.5 wt. % of polylactic acid and a racemization defect rate between 0 and 2.5 wt. % of polylactic acid.

The present invention therefore relates to a method of bulk polymerization for obtaining isotactic polylactic acid possessing a low tacticity defect rate. “Tacticity defect” means the sum of the insertion defect percentage and racemization defect percentage.

According to the present invention, a “bulk process” means any polymerization taking place in the absence of solvent.

The present invention also relates to the production of polylactic acid of configuration L or D according to the method of the invention.

The term “polylactic acid” is equivalent to the term “polylactide acid”.

The term “poly-L-lactic acid” or “poly-L-lactide acid”, as used in the invention, refers to an isotactic polymer of general formula (IV) in which n is an integer between 100 and 100 000:

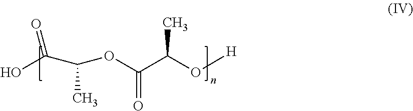

The term “insertion defect”, as used in the invention, refers to the incorporation, in a homopolymer of given stereoregularity, of a lactide unit of opposite stereoregularity. For example, insertion defect in a poly-L-lactic acid refers to the incorporation of D-D lactide in the polymer chain of poly-L-lactic acid, and therefore to the presence of a dimer unit DD of formula (Ia)

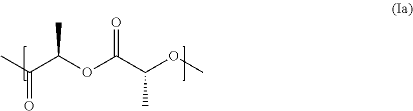

in poly-L-lactide acid. The term “insertion defect percentage” therefore refers to the proportion by weight of unit of opposite stereoregularity along the polymer chain of a polylactic acid of given stereoregularity.

The term “racemization defect”, as used in the invention, refers to incorporation of meso-lactide in the polymer chain of isotactic polylactic acid or to reversal of the configuration of an asymmetric carbon of the lactide during polymerization. The term “racemization defect percentage” therefore refers to the proportion by weight of meso-lactide units incorporated in the polymer chain of polylactic acid. The term “meso-lactide unit” refers to a unit of general formula (II) or (III):

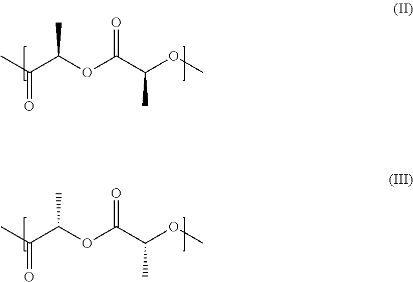

In the method of the present invention, it is desirable to use lactide of stereochemical configuration D-D or L-L having an optical purity also called isomeric purity of L or D of at least 99.5 wt. %, preferably of at least 99.8 wt. %.

Preferably, the L-L lactide used in the method comprises a content of D-D lactide below 0.2%, and the D-D lactide used in the method comprises a content of L-L lactide below 0.2%.

Preferably, the chemical purity of the starting lactide is such that the residual acidity is less than 20 meq/kg and residual water is less than or equal to 100 ppm, more preferably less than or equal to 50 ppm.

The term “reaction time or residence time” as used in the invention refers to the time interval during which poly-L-lactic acid or poly-D-lactic acid is present in a reactor or a cascade of reactors, in the extruder or any other polymerization equipment that can operate in batch mode or continuous mode, with or without a stirrer.

According to a preferred embodiment of the invention, said method of preparation can be carried out at a temperature between 170 and 200° C., preferably at a temperature between 170 and 195° C., more preferably at a temperature between 175 and 185° C., even more preferably at a temperature between 175 and 180° C. Any configuration of the reactor that can promote temperature control, for example an exchange surface/reaction volume ratio or any other system known by a person skilled in the art, will be preferred within the scope of the invention.

According to another preferred embodiment of the invention, said method of preparation can be carried out for a reaction time between 5 and 75 minutes, preferably between 10 and 60 minutes, more preferably between 10 and 45 minutes, even more preferably between 15 and 30 minutes.

According to another preferred embodiment of the invention, said method of preparation can be carried out jointly at a temperature between 170 and 195° C. and for a reaction time between 10 and 75 minutes, preferably at a temperature between 170 and 185° C. and a reaction time between 15 and 30 minutes, preferably at a temperature between 170 and 180° C. and a reaction time between 15 and 25 minutes.

Joint control of the optical or isomeric purity of the monomer and of the operating conditions of the method of preparation makes it possible to obtain a polymer of polylactic acid having higher crystallinity and greater heat resistance.

According to a preferred embodiment of the invention, said method of preparation can be carried out in the presence of an inert gas. The inert gas can be selected from the group comprising nitrogen, argon, neon, krypton, xenon, helium. Preferably, the inert gas can be nitrogen or argon, more preferably, the inert gas can be nitrogen. The inert gas can contain between 0 and 100 ppm of H₂O, preferably between 0 and 50 ppm of H₂O, more preferably between 0 and 10 ppm of H₂O. Preferably, said inert gas can have a content of H₂O less than or equal to 5 ppm.

According to another preferred embodiment of the invention, said contacting of the lactide with the catalytic system and said polymerization reaction can be carried out at atmospheric pressure and in the presence or absence of an inert gas.

According to another preferred embodiment of the invention, said contacting of the lactide with the catalytic system and said bulk polymerization reaction can be carried out at reduced pressure and in the presence or absence of an inert gas.

Said method can be carried out in batch mode or in continuous mode in a polymerization reactor or a cascade of polymerization reactors optionally equipped with one or more high-viscosity stirrers or by extrusion in a single-screw, twin-screw or multiscrew extruder (or horizontal reactor). Preferably the method is continuous. Preferably the method is carried out in a reactor optionally with a high-viscosity stirrer.

Said method of polymerization can be carried out at reduced pressure, at increased pressure or at atmospheric pressure. In particular, when polymerization takes place in a reactor equipped with a high-viscosity stirrer, the method can be carried out at reduced pressure, at increased pressure or with nitrogen flow, preferably at increased pressure of an inert gas.

According to another particular embodiment, polymerization is carried out by extrusion in an extruder. In this case, the method can be carried out with inert gas flow.

According to the method of the invention, polymerization of the lactide is continued up to a degree of conversion between 80% and the thermodynamic limit, which preferably is greater than 90%.

The method of the present invention is carried out in the presence of at least one catalytic system. Said catalytic system comprises at least one catalyst and optionally at least one cocatalyst.

The catalyst is preferably of formula (M) (X¹, X² . . . X^{m})ₙ in which
M is a metal selected from the group comprising the elements of columns 3 to 12 of the periodic table as well as the elements Al, Ga, In, TI, Sn, Pb, Sb and Bi,
X¹, X², . . . X^{m} is a substituent selected from the group comprising C₁-C₂₀ alkyl, C₆₋₃₀ aryl, oxide, carboxylate, halide, C₁-C₂₀ alkoxy and compounds containing elements of group 15 and/or 16 of the periodic table,
m is an integer between 1 and 6, and
n is an integer between 1 and 6.

In the sense of the present invention “alkyl” means a linear or branched, saturated hydrocarbon group with from 1 to 20 carbon atoms, in particular from 1 to 16 carbon atoms, in particular from 1 to 12 carbon atoms, in particular from 1 to 10 atoms and more particularly from 1 to 6 carbon atoms. For example, radicals such as methyl, ethyl, isopropyl, n-butyl, t-butyl, t-butylmethyl, n-propyl, pentyl, n-hexyl, 2-ethylbutyl, heptyl, octyl, nonyl, or decyl are included in this definition.

In the sense of the present invention “aryl” means an aromatic ring comprising 1 to 3 aromatic nuclei, optionally fused, with 6 to 20 carbon atoms, notably 6 to 10 carbon atoms. As examples of aryl groups suitable for application of the invention we may mention phenyl, phenethyl, naphthyl or anthryl.

In the sense of the present invention “alkoxy” means a group of general formula R—O— where R is an alkyl group as defined above. We may mention, as examples, the methoxy, ethoxy, propoxy, t-butoxy, n-butoxy, isobutoxy, sec-butoxy, n-pentoxy, isopentoxy, sec-pentoxy, t-pentoxy, hexyloxy, isopropoxy groups.

“Halide” means a chloride, a fluoride, an iodide or a bromide.

Preferably, the co-catalyst is of general formula (Y)(R¹, R² . . . R^{q})ₛ in which
Y is an element selected from the elements of group 15 and/or 16 of the periodic table,
R¹, R² . . . R^{q} is a substituent selected from the group comprising C₁-C₂₀ alkyl, C₆-C₂₀ aryl, oxide, halide, alkoxy, aminoalkyl, thioalkyl, phenyl-oxy, aminoaryl, thioaryl, and compounds containing elements of group 15 and/or 16 of the periodic table.
q is an integer between 1 and 6, and
s is an integer between 1 and 6.

“Aminoalkyl” means an alkyl group bearing a group —NR^{a}₂ on its carbon chain where R^{a} is an alkyl, an aryl or a hydrogen.

“Thioalkyl” means an alkyl group bearing a group R^{b}S— where R^{b} is an alkyl, an aryl or a hydrogen.

“Aminoaryl” means an aryl group having a unit —NR^{c}₂ where R^{c} is an aryl, an alkyl or a hydrogen.

“Thioaryl” means an aryl group having a unit R^{d}S— where R^{d} is an aryl, an alkyl or a hydrogen.

Preferably, the catalytic system comprises tin bis(2-ethylhexanoate) as catalyst and triphenylphosphine PPh₃ as co-catalyst. This catalytic system is known and described for example in document U.S. Pat. No. 6,166,169. The molar ratio of co-catalyst to catalyst can be between 1/10 and 10/1, preferably between 1/3 and 3/1. More preferably, the molar ratio of co-catalyst to catalyst can be 1/1.

The molar ratio of lactide to catalyst can be between 200/1 and 10 000/1, preferably between 1000/1 and 7500/1, more preferably between 1500/1 and 6000/1.

The method of the present invention also comprises the use of an initiator. The initiator can be the residual water contained in the lactide, an alcohol or an amine. The alcohol or amine can be aliphatic or aromatic of general formula R¹⁰-(A)ₛ in which A is OH or NH₂ and s is 1 or 2, R¹⁰ is an alkyl having from 1 to 20 carbon atoms or an aryl having from 6 to 30 carbon atoms. Preferably, R¹⁰ is an alkyl having from 3 to 12 carbon atoms or an aryl having from 6 to 10 carbon atoms.

Among the alcohols, we may mention isopropanol, butanediol, octanol-1 and dodecanol.

Among the amines, we may mention isopropylamine and 1,6-hexanediamine.

According to a preferred embodiment of the invention, the molar ratio of lactide to initiator when the latter is an alcohol or an amine can be between 50/1 and 1000/1, preferably between 100/1 and 750/1, more preferably between 200/1 and 600/1. When the initiator is the residual water present in the lactide, the molar ratio of lactide to water can be in the same ranges as those mentioned when the initiator is an alcohol or an amine.

Preferably, the initiator is an alcohol or an amine.

The present invention also relates to production of polylactic acid of configuration L or D by the method of the present invention.

The polylactic acid of configuration L or D that can be obtained by the method of the invention has an insertion defect percentage between 0 and 0.5%, preferably between 0 and 0.3%, more preferably between 0 and 0.2% and a racemization defect percentage between 0 and 2.5%, preferably between 0 and 1.5%, more preferably between 0 and 1%. More preferably, the polylactic acid of configuration L or D that can be obtained by the method of the invention has 0% of insertion defect in its polymer chain. Thus, the tacticity defect of said polylactic acid can result solely from a racemization defect. The insertion and racemization defects are detected by carbon-13 nuclear magnetic resonance (¹³C-NMR).

The low insertion and racemization defect percentage within the polymer chain makes it possible to obtain a polylactic acid whose crystallization temperature, observable by differential scanning calorimetry according to method ISO 11357-2, during cooling after the first heating is between 110 and 120° C. and that observable during cooling after the second heating is between 90 and 100° C. The polymers thus obtained have improved crystallinity and improved heat resistance.

The polylactic acid of configuration L or D that can be obtained by the method of the invention has a number-average molecular weight (Mn) between 60 000 and 200 000, preferably between 70 000 and 175 000, more preferably between 80 000 and 150 000 when it is measured by gel permeation chromatography relative to a polystyrene standard in chloroform at 35° C. The ratio of the weight-average molecular weight (Mw) to the number-average molecular weight (Mn) is generally between 1.2 and 2.8.

In the present invention, the terms “percentage of D-mer” and “percentage of L-mer” refer respectively to the monomer units of type D and of type L that occur in polylactide. This percentage is determined by an enzymatic method.

The poly-L-lactide acid that can be obtained by the method of the invention preferably has a percentage of D-mer less than or equal to 1.75 wt. % of poly-L-lactide acid, preferably less than 1.5%, more preferably less than 1%.

The poly-D-lactide acid that can be obtained by the method of the invention preferably has a percentage of L-mer less than or equal to 1.75 wt. % of poly-D-lactide acid, preferably less than 1.5%, more preferably less than 1%.

The present invention also relates to the use of the isotactic polylactic acid as obtained for the manufacture of packaging such as packaging films for sweetmeats, for the manufacture of disposable items such as beakers or for the manufacture of textiles, for example fibres. The present invention also relates to the use of the isotactic polylactic acid as obtained in the area of durable goods.

### EXAMPLES

### 1. Protocol for the Determination of Insertion Tacticity and Racemization Tacticity by ¹³C-NMR and Protocol for the Determination of Overall D-mer or L-mer Tacticity by Enzyme Assay

### a) Identification of the Insertion Peaks in Poly-L-Lactide (PL-LA)

PL-LA models were polymerized in mild conditions in a flask so as not to cause racemization of the PL-LA and so as to insert D-LA units between L-LA units.

These syntheses of PL-LA models were carried out in the following conditions:
in solution in toluene: 100 g of lactide in 400 ml of toluene,
in the presence of the catalytic system tin bis(2-ethylhexanoate) and PPh₃,
for 72 h at 90° C.

Three PL-LA models were prepared:
a PL-LA with 100% of L-lactide.
a PL-LA with a mixture of 95% of L-lactide and 5% of D-lactide.
a PL-LA with a mixture of 90% of L-lactide and 10% of D-lactide.

Scheme 1 illustrates insertion of D-lactide in a polymer chain of PL-LA.

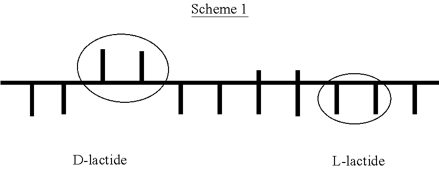

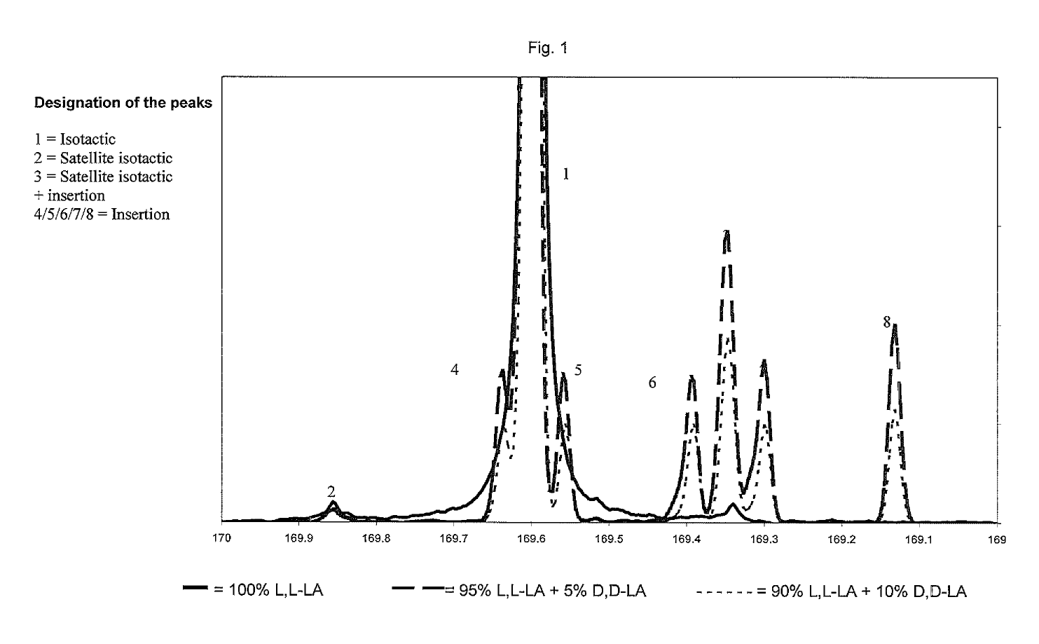

A ¹³C-NMR analysis on the signal of the C═O peak was performed on 3 PL-LA models. The NMR spectrum obtained for the 3 PL-LA models is shown in FIG. 1.

Analysis of the NMR spectrum shown in FIG. 1 enabled us to determine the 4 peaks resulting from tacticity defects due to insertion of the D-lactide unit in the L-lactide chain.

### b) Identification of the Racemization Peaks

The PL-LA synthesized in controlled conditions of high-temperature polymerization undergoes controlled racemization of the L-LA to meso-LA. To identify the peaks resulting from tacticity defects due to racemization of L-lactide, a PL-LA obtained from very pure L-LA (>99.5% L-LA) was synthesized in the following conditions:
in the bulk in a continuous stirred reactor,
in the presence of the catalytic system tin bis(2-ethylhexanoate) and PPh₃,
for 45 minutes at 185° C.

Scheme 2 illustrates insertion of meso-lactide obtained by racemization in a polymer chain of PL-LA.

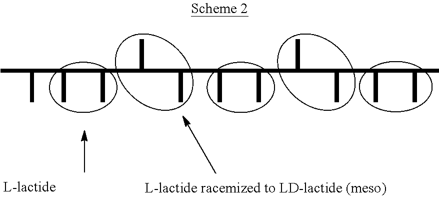

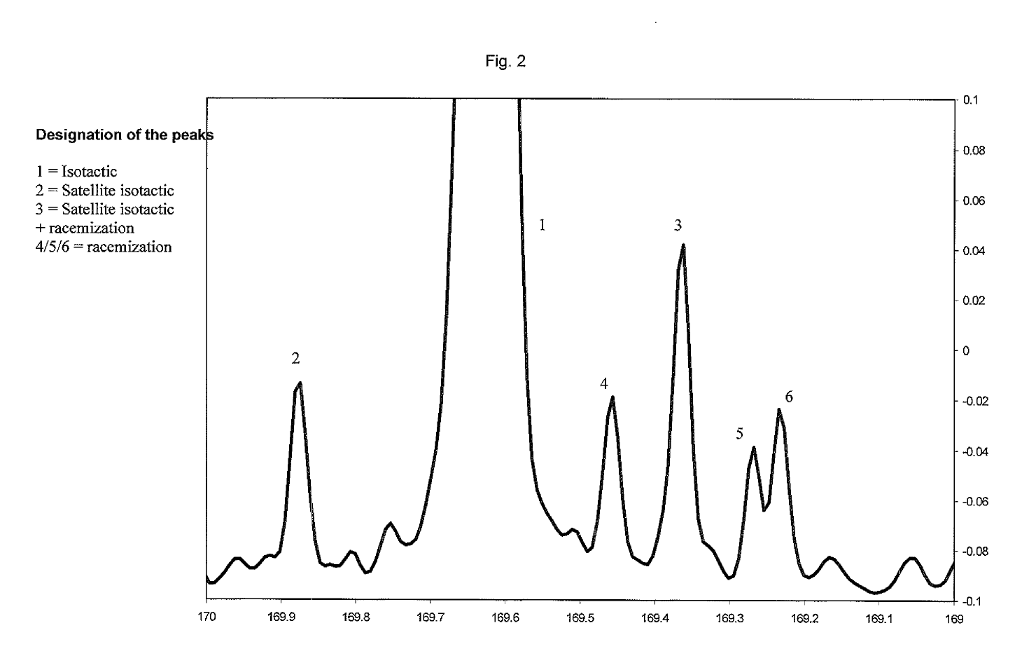

A ¹³C-NMR analysis of the signal of the C═O peak was performed on the racemized PLA. The NMR spectrum obtained is shown in FIG. 2. Analysis of the spectrum makes it possible to determine the peaks resulting from tacticity defects due to racemization of the L-lactide, which causes LD-lactide or meso-lactide insertions.

### c) Example of ¹³C-NMR Analysis of Commercial Products

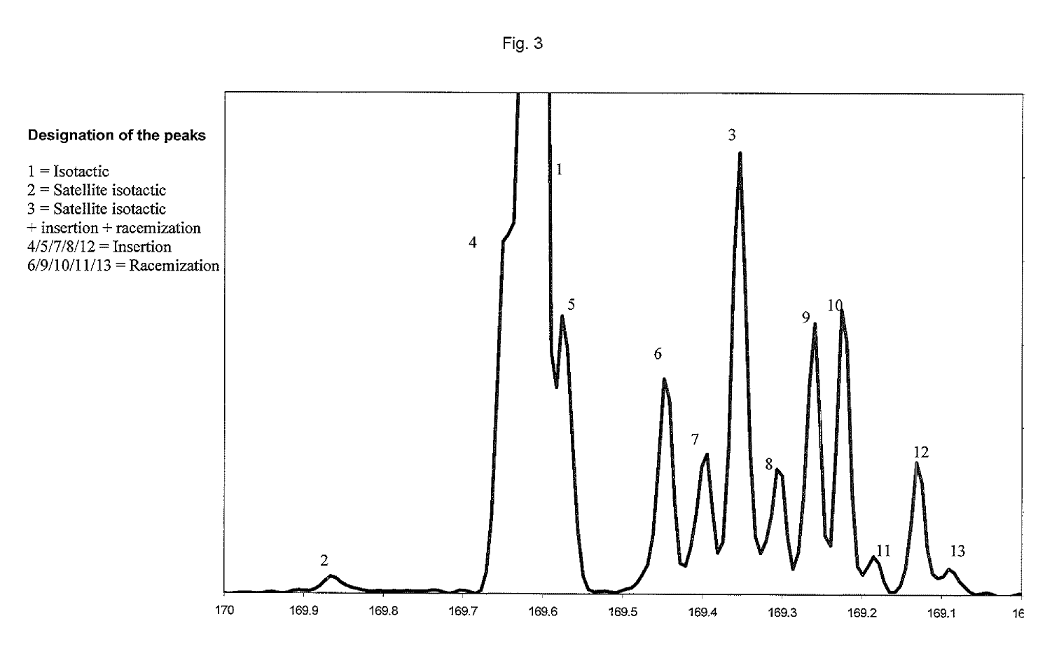

PLAs available on the market or commercial PLAs prepared by a method usually employed for polymerization of L-lactide were analysed. For these PLAs, the peaks of tacticity defects due to insertion and the peaks of tacticity defects due to racemization were identified on the ¹³C-NMR spectrum. The NMR spectrum obtained is shown in FIG. 3. Analysis and interpretation of the spectrum in FIG. 3 in the light of the spectra of FIGS. 1 and 2 enable us to attribute the peaks due to defects of insertion and those due to defects of racemization. It is noted that there is a combined signal around 169.35 ppm. This peak is due to insertion and racemization defects. Moreover, a part of this peak is due to the satellite of the isotacticity peak L.

### d) Enzyme Assay for the Determination of the Overall D-mer or L-mer Tacticity

The lactides are dimers. Enzymatic analysis makes it possible to measure all of the monomer of one of the two forms of optically active enantiomers present in the dimer, for example the content of D-mer or L-mer in the lactide in order to check its purity. This analysis can also be performed on PL-LA and PD-LA after polymerization. One unit of L-LA in PL-LA will give 100% of L-mer and one unit of D-LA in PD-LA will give 100% of D-mer. One unit of meso-LA will give 50% of D-mer and 50% of L-mer. Therefore, during racemization of L-LA or of D-LA, one meso-LA equivalent will be present.

The lactide can be represented by the following 2 chiral forms:

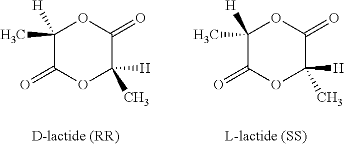

The meso-lactide (non-chiral) can be represented as follows:

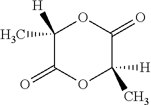

This meso-lactide is not available commercially.

Scheme 3 illustrates insertion of D-lactide and of “meso-lactide” obtained by racemization in a polymer chain of PL-LA

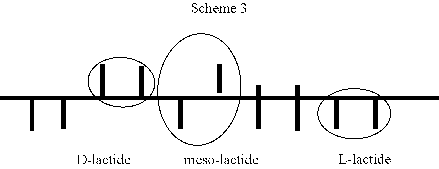

In the example of scheme 3, one unit (20%) of D-LA is inserted and one unit (20%) of L-LA has racemized. Enzymatic analysis will therefore give 30% of D-mer in this sample.

The enzymatic method makes it possible to determine the percentage of D-mer (monomer unit of type D) that will be found in the polymer chain of PL-LA or the percentage of L-mer (monomer unit of type L) that will be found in the polymer chain of PD-LA. The enzymatic method will never allow us to determine the origin of this monomer unit: insertion or racemization.

### e) Quantitative Determination of Overall Tacticity Defects, Insertion and Racemization Tacticity Defects by Combining the Two Techniques ¹³C-NMR and Enzymatic Method

If for the polymer chain represented by scheme 3, the area of the peaks of insertion defects and the area of the peaks of racemization defects (meso equivalent) is for example 2 to 1 by ¹³C-NMR, the distribution of the defects is as follows: 67% of insertion defects and 33% of racemization defects. Moreover, if enzymatic measurement of this sample gives us 30% of D-mer (or 30 wt. % of equivalent D-LA) and knowing that 67% of defects are insertion defects, this therefore corresponds to 67% of 30% of D-mer, i.e. 20% of D-mer and therefore to 20% of D-LA.

Regarding the racemization defects, knowing that these are of the order of 33%, this corresponds to 10% of D-mer and 20% of meso-LA equivalent.

We can thus calculate the amounts of L-LA, D-LA and meso-LA (LD-LA) present in the PL-LA chain from:

$$wt . \% D \text{-} LA = [ \frac{STPI}{STPI + STPR} ] \times \% D \text{-} mer$$

in which “STPI” represents the total area of the insertion peaks and “STPR” the total area of the racemization peaks determined by NMR multiplied by the percentage of D-mer determined by the enzymatic method. The wt. % of D-LA therefore represents the insertion tacticity.

$$wt . \% meso \text{-} LA = [ [ \frac{STPR}{STPR + STPI} ] \times \% D \text{-} mer ] \times 2$$

The wt. % meso-LA therefore represents the racemization tacticity.

wt. % L-LA=100−(wt % D-LA+wt. % meso-LA)

Overall tacticity=insertion tacticity+racemization tacticity

### f) Analytical Method

### 1. Enzymatic Method

The stereochemical purity of the poly-L-lactic acid or of the poly-D-lactic acid of the invention was determined from the respective content of L-mer or of D-mer. The enzymatic method was used for this determination.

The principle of the method is as follows: The L-lactate and D-lactate ions are oxidized to pyruvate respectively by the enzymes L-lactate dehydrogenase and D-lactate dehydrogenase using nicotinamide-adenine dinucleotide (NAD) as coenzyme. To force the reaction in the direction of formation of pyruvate, it is necessary to trap this compound by reaction with hydrazine. The increase in optical density at 340 nm is proportional to the amount of L-lactate or of D-lactate present in the sample.

The samples of polylactic acid were prepared by mixing 25 ml of sodium hydroxide (1 mol/L) with 0.6 g of PLA. The solution was boiled for 8 h and then cooled. The solution was then adjusted to neutral pH by adding hydrochloric acid (1 mol/L), then deionized water was added in a sufficient amount to give 200 ml.

The samples were then analysed on a Vital Scientific Selectra Junior analyser using, for L-mer determination of poly-L-lactide acid, the box titled “L-lactic acid 5260” marketed by the company Scil and for D-mer determination of poly-D-lactide acid, the box titled “L-lactic acid 5240” marketed by the company Scil. During the analysis, a reactive blank and calibration using the calibrant “Scil 5460” are used.

Determination of the optical or isomeric purity of the lactide is carried out by the same enzymatic method. Only the sample preparation is different. The samples of lactide were prepared by mixing 25 ml of sodium hydroxide (1 mol/L) with 0.6 g of lactide. The solution was mixed and then left at rest for half an hour before being adjusted to neutral pH by adding hydrochloric acid (1 mol/L), then deionized water was added in a sufficient amount to give 200 ml.

### 2. NMR Method

The presence of insertion and racemization defects was determined by carbon-13 nuclear magnetic resonance (NMR) (Avance, 500 MHz, 10 mm SELX probe). The samples were prepared from 250 mg of polylactic acid dissolved in 2.5 to 3 ml of CDCl₃.

### 2. Examples 1-4

The method of the invention was applied for preparing various samples of isotactic polylactide. The starting lactide of stereochemical configuration L-L having an isomeric purity greater than 99.5 wt. % was brought in contact with the salt tin(II) bis(2-ethylhexanoate) in the presence of triphenylephosphine, PPh₃. The molar ratio of lactide to catalyst (lactide/catalyst) was 4000. The method was carried out at atmospheric pressure with nitrogen flow in a continuous horizontal reactor equipped with a stirrer. The residual water content of the lactide was between 25 and 50 ppm. The polymerization conditions such as temperature, residence time and stirrer rotary speed for the various tests are given in Table 1.

The percentage of L-mer was determined by the enzymatic method. The percentage of D-mer was determined by calculation (100%−% L-mer).

The presence of insertion and racemization defects was determined by carbon-13 nuclear magnetic resonance (NMR).

The percentage of starting lactide that had not reacted, called residual lactide, was measured by ¹H-NMR. The results are shown in Table 1 below.

TABLE 1

| | Temper- | Rotary | Residence | Absolute | Residual | | | Insertion | Racemization | | |
|---|---|---|---|---|---|---|---|---|---|---|---|
| | ature | speed | time | pressure | lactide | L-mer | D-mer | defect | defect | | |
| Ex. | (° C.) | (round/min) | (min) | (mbar) | (%) | (%) | (%) | (% DD-LA) | (% LD-LA) | Mn | Mw/Mn |
| 1 | 175 | 50 | 30 | 1013 | 11.5 | 98.9 | 1.1 | <0.2 | 1.8 | 117.000 | 1.90 |
| 2 | 195 | 20 | 30 | 1013 | 7.5 | 99 | 1 | <0.2 | 1.6 | 121.000 | 1.93 |
| 3 | 180 | 30 | 42 | 60 | 6.5 | 98.8 | 1.2 | <0.2 | 2 | 69.000 | 2.40 |
| 4 | 185 | 35 | 45 | 1013 | 8.7 | 98.7 | 1.3 | <0.2 | 2.2 | 109.000 | 1.86 |

### 3. Examples 5-9

Three commercial polymers of poly-L-lactic acid (C to E) prepared by a method usually employed for polymerization of lactide were compared with the two polymers of poly-L-lactic acid (A and B) obtained by the method of the invention.

The polymers of poly-L-lactic acid A and B were synthesized in a reactor from L-lactide of optical purity above 99.5%, at a temperature of 175° C. and with a residence time of 25 minutes in the presence of tin(II) bis(2-ethylhexanoate) and triphenylephosphine PPh₃. The molar ratio of lactide to catalyst (lactide/catalyst) was 4000. The polymerization of poly-L-lactic acid A was carried out at atmospheric pressure (1013 mbar) with nitrogen flow. The polymerization of polylactic acid B was carried out under nitrogen at a pressure of 1213 mbar. 1-Dodecanol was used as initiator in a molar ratio lactide/alcohol amounting to 681. The results are presented in Table 2.

TABLE 2

| | Example 5 | Example 6 | Example 7 | Example 8 | Example 9 |
|---|---|---|---|---|---|
| | (polymer A) | (polymer B) | (polymer C) | (polymer D) | (polymer E) |
| Racemization defect | 1.0 | 1.0 | 15.5 | 11.7 | 12.6 |
| (% LD-LA) | | | | | |
| Insertion defect | <0.2 | <0.2 | 4.1 | 1.2 | 1.3 |
| (% DD-LA) | | | | | |
| D-mer (%) | 0.7 | 0.7 | 11.9 | 7.0 | 7.6 |
| Mn | 66 000 | 102 000 | 110 000 | 80 000 | 86 000 |
| Mw/Mn | 1.53 | 1.90 | 2.0 | 2.0 | 2.0 |

The polymers of poly-L-lactic acid A and B according to the invention display little or no insertion defect in contrast to the other polymers of polylactic acid. Their percentages of racemization defect (mesolactide equivalent) are also far lower than those of the commercial polymers C to E.

The crystallization temperature of samples A to E was determined by differential scanning calorimetry according to method ISO 11357-2. According to this method, the samples were heated from 20° C. to 200° C. at a rate of 10° C. per minute, then cooled from 200° C. to 20° C. at a rate of 20° C. per minute and then heated from 20° C. to 200° C. at a rate of 10° C. per minute.

The crystallization temperature measured during the second heating of polymers A and B was between 100 and 120° C. A crystallization phenomenon was also observable during cooling after the first heating between 90 and 100° C. for said polymers. No crystallization temperature is observed on the fusion thermograms of samples of the commercial products C to E.

### 4. Example 10

In this example, poly-L-lactic acid was synthesized from L-L-lactide with optical purity above 99.5%, in a twin-screw extruder (L/D ratio: 56) at a temperature of 195° C. for 20 minutes in the presence of tin(II) bis(2-ethylhexanoate) and triphenylphosphine. The molar ratio of lactide to catalyst (lactide/catalyst) was 5000. The polymerization of poly-L-lactic acid was carried out at atmospheric pressure with argon flow. Octanol was used as initiator. The molar ratio of lactide to octanol (lactide/octanol) was 400.

The amount of L-mer, determined by an enzymatic method on the polymer obtained, is 99.6%. The insertion defect percentage (% DD-LA) is below 0.2% and the racemization defect percentage (% LD-LA) is 0.5%.

The number-average molecular weight is 74 000 and the Mw/Mn ratio is 1.76.

The crystallization temperature of the polymer obtained was determined by the same method as that mentioned in example 3. The crystallization temperature measured during the second heating of said polymer was between 100 and 120° C. A crystallization phenomenon was also observable during cooling after the first heating between 90 and 100° C. for said polymer.

1. Method of bulk polymerization for obtaining:
polylactic acid of configuration L, with number-average molecular weight between 60 000 and 200 000 having a percentage of dimer unit D-D of formula (Ia) 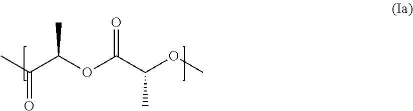
between 0 and 0.5 wt. % of poly-L-lactic acid and a percentage of dimer unit D-L and/or L-D of formulae (II) and (III) 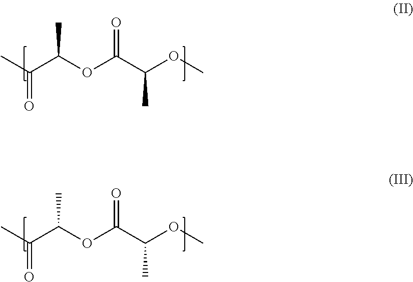
between 0 and 2.5 wt. % of poly-L-lactic acid,
or
polylactic acid of configuration D, with number-average molecular weight between 60 000 and 200 000 having a percentage of dimer unit L-L of formula (Ib) 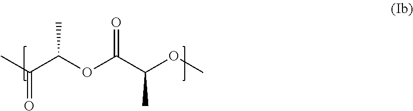
between 0 and 0.5 wt. % of poly-D-lactic acid and a percentage of dimer unit D-L and/or L-D of formulae (II) and (III) 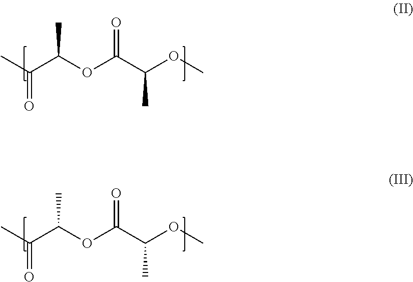
between 0 and 2.5 wt. % of poly-D-lactic acid, characterized in that bulk polymerization is carried out, consisting of bringing into contact, at a temperature between 170 and 200° C. and for a reaction time between 5 and 75 minutes, the corresponding lactide of stereochemical configuration L-L or D-D having an optical purity of L or D of at least 99.5 wt. % with at least one catalytic system in the presence of an initiator to form poly-L-lactic acid or poly-D-lactic acid.

2. Method according to claim 1, wherein the lactide of stereochemical configuration L-L or D-D has an optical purity of L or D of at least 99.8%.

3. Method according to claim 1, wherein the initiator is selected from the group consisting of water, an alcohol or an amine of general formula R¹⁰-(A)ₛ in which A is OH or NH₂, s is 1 or 2 and R¹⁰ is a substituted or unsubstituted alkyl or aryl group.

4. Method according to claim 1, wherein said method is carried out at a temperature between 170 and 185° C. and a reaction time between 15 and 45 minutes.

5. Method according to claim 1, wherein said method of polymerization is carried out at reduced pressure, at increased pressure or at atmospheric pressure.

6. Method according to claim 5, wherein said method is carried out in the presence of an inert gas.

7. Method according to claim 1, wherein said method is a continuous method.

8. Method according to claim 1, wherein said method is carried out in a reactor with a high-viscosity stirrer.

9. Method according to claim 8, wherein said method is carried out at increased pressure of nitrogen.

10. Method according to claim 1, wherein said method is carried out by extrusion in an extruder.

11. Method according to claim 10, wherein said method is carried out with inert gas flow.

12. Poly-L-lactic acid obtainable by the method according to claim 1.

13. Poly-L-lactic acid according to claim 12, wherein the percentage of dimer unit D-D is between 0 and 0.3%.

14. Poly-D-lactic acid obtainable by the method according to claim 1.

15. Poly-D-lactic acid according to claim 14, wherein the percentage of dimer unit L-L is between 0 and 0.3%.

16. (canceled)

17. (canceled)

18. Method according to claim 8, wherein said method is carried out with nitrogen flow.

19. Method according to claim 11, wherein said inert gas flow is nitrogen.

20. Articles of manufacture comprising the polylactic acid obtainable by the method of claim 1.

21. Durable goods comprising the polylactic acid obtainable by the method of claim 1.
